(19) United States
(12) Patent Application Publication
(10) Pub. No.: US 2009/0000602 A1
(43) Pub. Date: Jan. 1, 2009

(54) FUEL CONTROL DEVICE FOR A PLURALITY OF FUEL SOURCES

(75) Inventor: Takashi Horikawa, Natori-City (JP)

Correspondence Address: REISING, ETHINGTON, BARNES, KISSELLE, P.C., P O BOX 4390, TROY, MI, 48099-4390, US

(73) Assignee: Walbro Engine Management, L.L.C., Tucson, AZ (US)

(21) Appl. No.: 12/144,172

(22) Filed: Jun. 23, 2008

(30) Foreign Application Priority Data
Jun. 27, 2007 (JP) 2007-169131

(51) Int. Cl. F02M 37/00

(52) U.S. Cl. 123/510

(57) ABSTRACT

A fuel mixing device includes a fuel passage adapted to communicate fuel from at least one of a first fuel source or a second fuel source provided at a higher pressure than the first fuel with at least one of a first fuel path or a second fuel path. The device also includes a control valve permitting fuel flow through the second fuel path and out of the device when the first fuel is provided in the fuel passage so that the first fuel flows out of the device through both the first and second fuel paths, and the valve prevents fuel flow through the second fuel path and out of the device when the second fuel is provided in the fuel passage so that the second fuel flows out of the device only through the first fuel path.

### REFERENCE TO RELATED APPLICATION

This application claims the benefit of and priority from Japanese Patent Application Ser. No. 2007-169131, filed Jun. 27, 2007.

### FIELD OF THE INVENTION

The present invention relates generally to a fuel system component, and more particularly to a mixing device for gaseous fuel and air.

### BACKGROUND OF THE INVENTION

Internal combustion engines are capable of running on multiple types of gaseous fuels, such as propane and butane. Gaseous fuels may be stored at different pressures and have different BTU ratings per unit of gas volume or weight. A mixing device may use lesser or greater amounts of fuel per unit time depending on the type of fuel supplying the engine. For example, an engine may use less fuel per unit time of a fuel having a higher BTU rating than a fuel having a lower BTU rating. Providing an optimum amount of fuel mixed with air to the engine entails the use of pressure regulators that can compensate for the various BTU ratings and storage pressures of different gaseous fuels. Accordingly, when one type of fuel is used, one flow rate may be optimal. Switching fuels may involve a different optimum flow rate. Under these circumstances, individual and specific pressure regulators may be used to regulate each type of gaseous fuel.

### SUMMARY OF THE INVENTION

A fuel mixing device includes a fuel passage adapted to communicate fuel from at least one of a first fuel source or a second fuel source with at least one of a first fuel path or a second fuel path. The fuel may be a first fuel, or a second fuel provided at a higher pressure than the first fuel. The device also includes a control valve communicated with the fuel passage and adapted to selectively prevent fuel from being delivered out of the device from the second fuel path based on the pressure of fuel within the fuel passage. The control valve permits fuel flow through the second fuel path and out of the device when the first fuel is provided in the fuel passage so that the first fuel flows out of the device through both the first and second fuel paths, and the valve prevents fuel flow through the second fuel path and out of the device when the second fuel is provided in the fuel passage so that the second fuel flows out of the device only through the first fuel path.

In another implementation, a fuel mixing device to control the flow to an engine of at least one of a first fuel or a second fuel provided at a higher pressure than the first fuel includes a fuel passage through which fuel flows and is capable of receiving the first fuel or the second fuel. Also included is a shut-off valve communicated with the fuel passage and adapted to selectively permit fuel flow in the fuel passage downstream of the shut-off valve when the engine is operating. A pressure regulator is disposed downstream of the shut-off valve and adapted to receive fuel from at least a portion of the fuel passage. A first fuel path is disposed downstream of the pressure regulator. A second fuel path is disposed downstream of the pressure regulator and a control valve communicates with fuel in the fuel passage that, when closed, prevents fuel flow from the second fuel path to the engine. The control valve is responsive to the pressure of fuel acting on the valve to permit fuel flow through the second fuel path and out of the device when the first fuel is provided in the fuel passage so that the first fuel flows out of the device through both the first and second fuel paths, and the control valve prevents fuel flow through the second fuel path and out of the device when the second fuel is provided in the fuel passage so that the second fuel flows out of the device only through the first fuel path.

In another implementation, a fuel mixing device to control the flow to an engine of at least one of a first fuel or a second fuel provided at a higher pressure than the first fuel includes a body having an intake bore through which air flows and a fuel passage through which fuel flows and which is capable of receiving the first fuel or the second fuel and routing fuel toward the intake bore. Also included is a shut-off valve communicated with the fuel passage and adapted to selectively permit fuel flow in the fuel passage downstream of the shut-off valve when the engine is operating. A pressure regulator is disposed downstream of the shut-off valve and is adapted to receive fuel from at least a portion of the fuel passage. A first fuel path is disposed in the flow of fuel downstream of the pressure regulator and upstream of the intake bore. A second fuel path is disposed in the flow of fuel downstream of the pressure regulator and upstream of the intake bore. A control valve communicates with fuel in the fuel passage and, when closed, the control valve prevents fuel flow from the second fuel path to the engine. The control valve is responsive to the pressure of fuel acting on the control valve to permit fuel flow to the intake bore through the second fuel path when the first fuel is provided in the fuel passage so that the first fuel flows out of the device through both the first and second fuel paths, and the control valve prevents fuel flow to the intake bore through the second fuel path when the second fuel is provided in the fuel passage so that the second fuel flows out of the device only through the first fuel path.

### BRIEF DESCRIPTION OF THE DRAWINGS

The following detailed description of exemplary embodiments of the invention will best be understood with reference to the accompanying drawings, in which:

FIG. 1 is a front view of a fuel gas mixing device;

FIG. 2 is plan view of the device as seen in the direction indicated by arrow II in FIG. 1;

FIG. 3 is a sectional view taken along line III-III of FIG. 2;

FIG. 4 is a sectional view taken along line IV-IV of FIG. 2;

FIG. 5 is sectional view taken along line V-V of FIG. 2;

FIG. 6 is a sectional view taken along line VI-VI of FIG. 1;

FIG. 7 is a sectional view taken along line VII-VII of FIG. 2;

FIG. 8 is a diagram showing the fuel flow path when propane gas is used; and

FIG. 9 is a diagram showing the fuel flow path when butane gas is used.

### DETAILED DESCRIPTION OF EXEMPLARY EMBODIMENTS

A fuel mixing device may supply fuel from a first fuel source and/or a second fuel source that stores fuel at a higher pressure than the first fuel source. And the fuel mixing device may also use a first fuel path, a second fuel path, and a control valve. The first and second fuel paths may simultaneously supply fuel to the intake of an engine when the first (lower pressure) fuel source is supplied to the fuel mixing device. The first and second fuel paths are or may include one or more restrictions or metered flow areas that may be calibrated bores, passages of a desired diameter, apertures, or fuel jets that restrict the flow of fuel. The first fuel path may supply fuel to the intake without the second fuel path when the second (higher pressure) fuel source is supplied to the fuel mixing device. The control valve may be used to start or stop the flow of fuel from the second fuel path to the intake, depending on the pressure of the fuel supplied to the mixing device. For example, when the mixing device receives fuel from the first fuel source, it may be conveyed to the first fuel path, the second fuel path, and the control valve. The fuel pressure of the fuel from the first fuel source may act on the control valve and not provide enough force to close the valve. Alternatively, when the mixing device receives fuel from the second fuel source, the pressure of the fuel from the second source may close the control valve stopping the flow of fuel through the second fuel path. In one example, a valve, such as a Y-valve, may be used to selectively direct fuel to the mixing device from the first fuel source or the second fuel source.

The first fuel path may be sized to supply the engine with the higher pressure fuel from the second fuel source without the second fuel flowing through the second fuel path. The second fuel path may be sized to supply the engine with fuel when the both the first fuel path and the second fuel path supply the engine lower pressure fuel from the first fuel source.

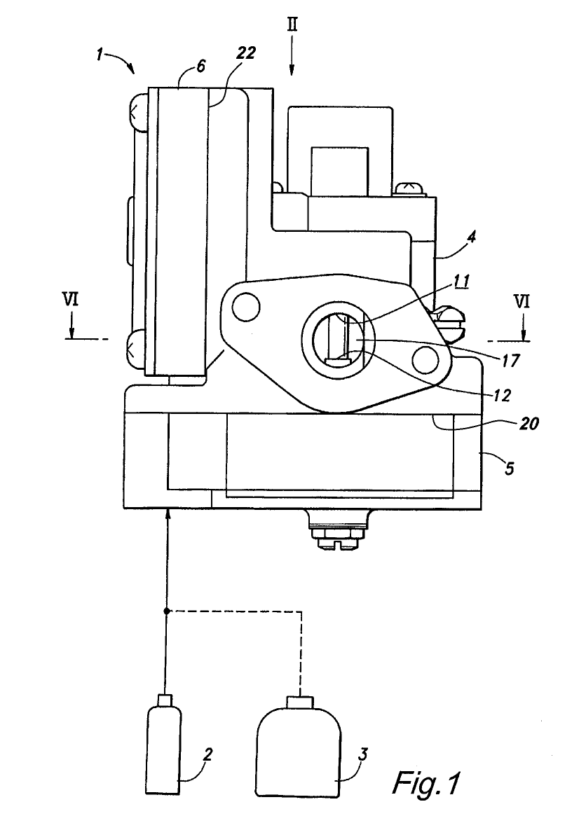

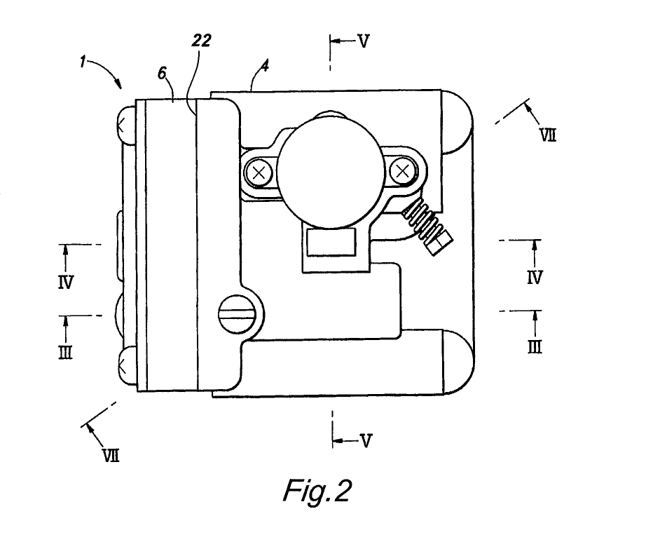

Referring in more detail to the drawings, one exemplary embodiment is shown in FIGS. 1-3 illustrating a gas-air mixing device 1. FIG. 1 shows a front view of a fuel mixing device 1 that may be configured to selectively supply the fuel from a plurality of fuel sources. For example, fuel may be supplied from a first fuel source, such as a butane gas cylinder 2, and a second fuel source such as a propane gas cylinder 3. The device 1 may also include a main body 4, a regulator valve assembly 5 attached to a first side 20 of the main body 4, and a shut-off valve assembly 6 attached to a second side 22 of the main body 4. Both the regulator valve assembly 5 and the shut-off valve assembly 6 may be attached to the first side 20 and second side 22, respectively, with threaded bolts or any other suitable fasteners. Additionally, the first side 20 and the second side 22 of the main body may be substantially perpendicular to each other.

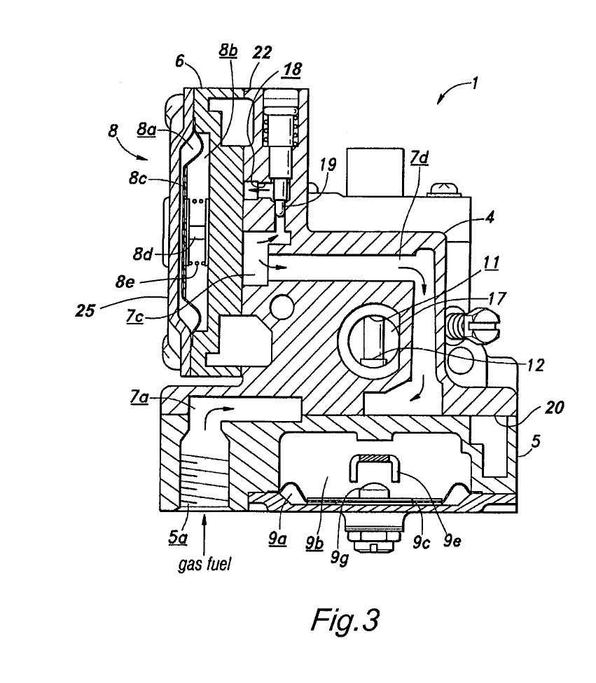

As shown in FIG. 3, the regulator valve assembly 5 may include a gas-fuel inlet 5(a) capable of receiving fuel from the butane gas cylinder 2 and/or the propane gas cylinder 3. The fuel inlet 5(a) may take the shape of a partially-threaded hole that may traverse the regulator valve assembly 5 and connect to the butane gas cylinder 2, the propane gas cylinder 3, or both. The fuel inlet 5(a) extends to an interface between the regulator valve assembly 5 and a fuel passage 7.

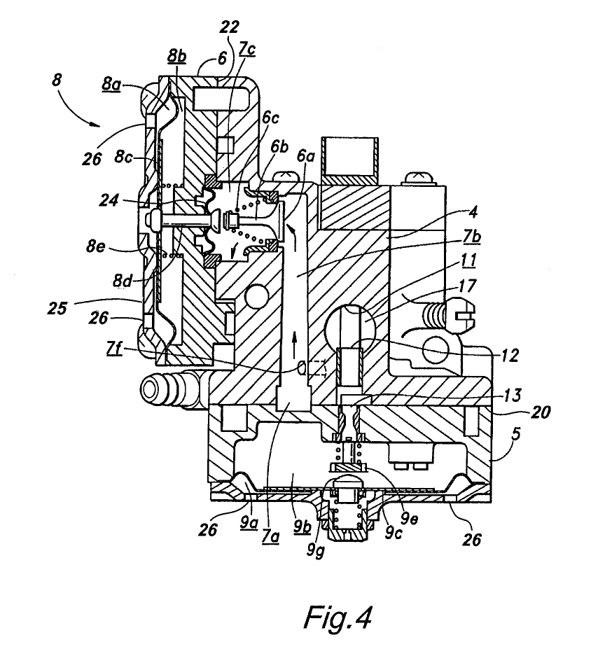

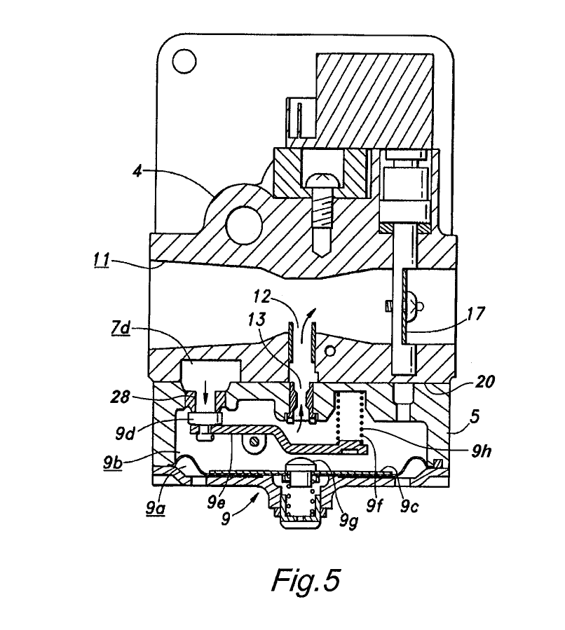

As shown in FIGS. 3-6, the fuel passage 7 may be indicated in segments 7(a)-7(f) and ultimately communicate fuel from the butane gas cylinder 2 and/or the propane gas cylinder 3 to an outlet of the device 1 for delivery to an engine intake 11. The fuel passage 7 may be formed in the main body 4 and may be also partially formed by the regulator valve assembly 5 and the shut-off valve assembly 6. FIG. 3 shows a first section 7(a) of the fuel passage 7 that may communicate with the fuel inlet 5(a) and route fuel from the butane gas cylinder 2 and/or the propane gas cylinder 3 into the main body 4. A second section 7(b) of the fuel passage 7 is illustrated in FIG. 4 and may be at least partially formed within the main body 4 and communicate fuel to the negative pressure assembly 6.

At the end of the second section 7(b) a valve member 6(a), valve stem 6(b), and valve spring 6(c) may selectively permit fuel to exit the section 7(b). The valve member 6(a), valve stem 6(b), and valve spring 6(c) may be carried by the main body 4. The valve member 6(a) may be conically-shaped and formed integrally and coaxially with the valve stem 6(b). The valve spring 6(c) may be disposed and/or engaged between the valve stem 6(b) and a spring retainer with the spring 6(c) resiliently urging the valve member 6(a) toward a valve seat 6(d) and into a normally closed position. When the valve member 6(a) is removed from the valve seat 6(d), fuel may flow out of the second section 7(b).

The negative pressure assembly 6 may include a shut-off valve 8 that interacts with the valve member 6(a) and may be attached to the assembly 6 on a side opposite the side attached to the second side 22 of the main body 4. The shut-off valve 8 may include an atmospheric chamber 8(a), a negative pressure chamber 8(b), a diaphragm 8(c) separating the atmospheric chamber 8(a) from the negative pressure chamber 8(b), and a valve member 8(d) attached or carried adjacent at one end to the diaphragm 8(c). Negative pressure generated by engine operation may generate a reduced pressure or a vacuum in the negative pressure chamber 8(b) thereby displacing the diaphragm 8(c) and moving the valve member 8(d) in an axial direction toward valve stem 6(b). The axial movement of the valve member 8(d) may displace the valve stem 6(b) moving the valve member 6(a) away from the valve seat 6(d). This permits fuel to flow from the second section 7(b) to a third section 7(c) of the fuel passage 7 that may be located between the main body 4 and the shut-off valve assembly 6 and is shown in FIGS. 3 and 4. A flexible shut-off valve seal 24 may attach to the valve member 8(d) at an end distal to the diaphragm 8(c) to reduce or prevent leakage between the third section 7(c) and the chamber 8(b). The valve seal 24 may be formed like a diaphragm and permit the movement of the valve member 8(d). Additionally, a valve spring 8(e) may be placed in the negative pressure chamber 8(b) coaxial to the valve member 8(d) to yieldably bias the diaphragm 8(c) and the valve member 8(d) away from the valve stem 6(b). The atmospheric chamber 8(a) may be defined in part by a lid 25 that has apertures 26 to maintain an air pressure in the chamber 8(a) equal to that of the atmosphere.

As discussed above, FIGS. 3-5 illustrate the third section 7(c) that may route fuel from the second section 7(b) past the valve member 6(a) and into a fourth section 7(d) of the fuel passage 7. Section 7(d) may communicate fuel from section 7(c) and be formed by the main body 4 and the regulator valve assembly 5.

As shown in FIGS. 3-5, the regulator valve assembly 5 includes a pressure regulator valve 9. The pressure regulator valve 9 may be attached to a first side 20 of the main body 4 and include an atmospheric chamber 9(a), a pressure regulating chamber 9(b), a diaphragm 9(c), and a valve member 9(d). Apertures 26 may connect the atmospheric chamber 9(a) to the atmosphere helping maintain the air pressure in the chamber 9(a) equal to the pressure surrounding the device 1. The pressure regulating chamber 9(b) receives fuel when the valve 9 is open and is separated from the atmospheric chamber 9(a) by the diaphragm 9(c). The regulator valve assembly 5 also may include a fuel pressure control lever 9(e) that may carry the valve member 9(d) at one end. The fuel pressure control lever 9(e) may be pivotally supported in the regulator valve assembly 5 and the valve member 9(d) may open and close an inlet port 28 or communication port between the pressure regulating chamber 9(b) and the fourth segment 7(d). A spring 9(f) may be received by a spring seat 9(h) formed as a recessed portion of the regulator valve assembly 5, where the seat 9(h) may be located in a side of the pressure regulating chamber 9(b) nearest the main body 4. The spring 9(f) may resiliently force the end of the fuel pressure control lever 9(e) distal to the valve member 9(d) away from the spring seat 9(h). Moving the distal end of the fuel pressure control lever 9(e) away from the spring seat moves the valve member 9(b) toward the inlet port 28 or communication port preventing fuel from entering the pressure regulating chamber 9(b). When a sufficient pressure drop is generated across the diaphragm 9(c), such as by a reduced pressure in the pressure regulating chamber 9(b), an activator 9(g) carried by the diaphragm 9(c), acts upon the end of the fuel pressure control lever 9(e) distal to the valve member 9(d) and may move it toward the spring seat 9(h) thereby pivoting the lever 9(e) and forcing the valve member 9(d) away from the inlet port 28 or communication port. Fuel then enters the pressure regulating chamber 9(b).

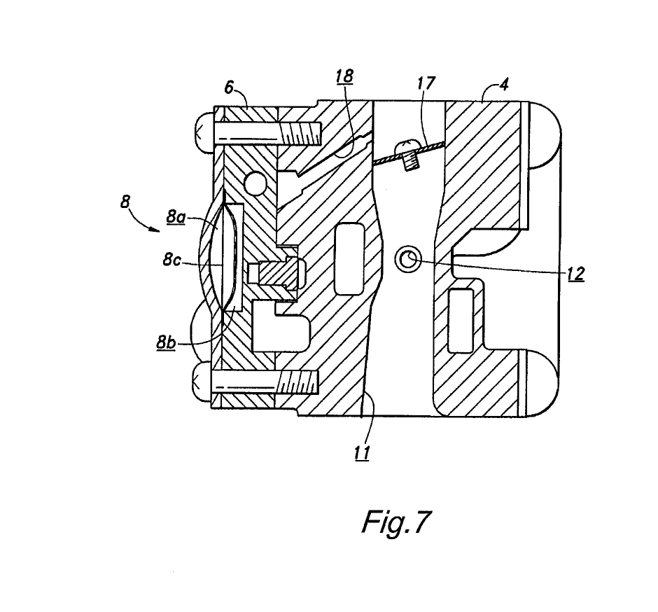

The main body 4 may include a venturi-type carburetor connected to an intake port of an internal combustion engine not shown. An intake bore 11 may form a part of the carburetor and extend centrally across a middle part of the main body 4 and a fuel ejection nozzle 12 may open into the intake bore 11. As shown in FIGS. 3 and 7, a bypass passage 18 or bleed passage may branch from the third segment 7(c) and extend to a position of the intake bore 11 downstream from a throttle valve 17. A bypass jet 19 or bleed passage restriction may adjust the flow of fuel and convey the fuel to the bypass passage 18. Both the bypass passage 18 and the bypass jet 19 are metered flow areas that may be simple passages of a desired diameter, apertures, nozzles, fuel jets, etc., that restrict the flow of fuel.

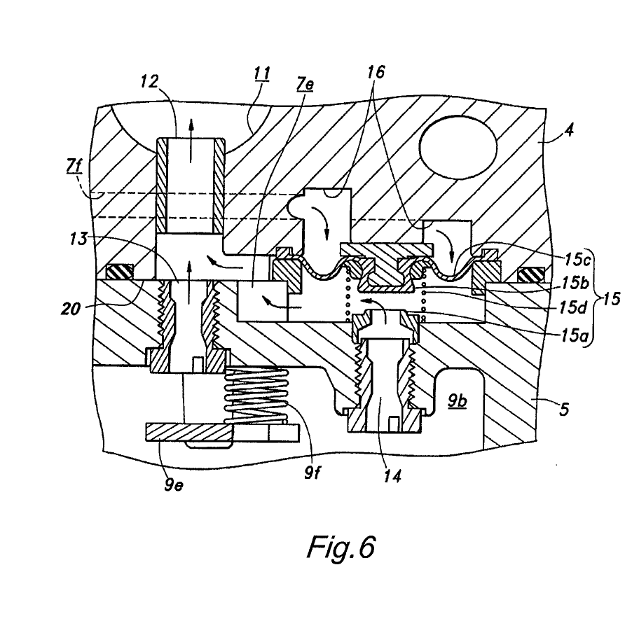

As illustrated in FIG. 6, the regulator valve assembly 5 also may include a first fuel path 13 that may communicate fuel from the pressure regulating chamber 9(b) to the fuel ejection nozzle 12 and ultimately to the intake bore 11. The regulator valve assembly 5 also includes a second fuel path 14 that may selectively communicate fuel to the fuel ejection nozzle 12 via a fifth segment 7(e) of the fuel passage 7 depending on the position of a control valve 15. The control valve 15 may be located between the second fuel path 14 and the fifth segment 7(e). The control valve 15 may include a valve seat 15(a) positioned on the downstream end of the second fuel path 14. The control valve may also include a diaphragm 15(c) and a valve member 15(b) integrally constructed and carried by the main body 4. A spring 15(d) may be positioned in a coaxial relationship with the second fuel path 14 within the fifth segment 7(e) and between the diaphragm 15(c) and a surface of the regulator valve assembly 5. The spring 15(d) may resiliently urge the valve member 15(b) away from the valve seat 15(a) opening the control valve 15 and allowing fuel to flow through the second fuel path 14.

A pressure chamber 16 may be partially defined by the diaphragm 15(c) and located on the side of the diaphragm 15(c) opposite section 7(e) and the spring 15(d). The pressure chamber 16 may communicate with a sixth segment 7(f) of the fuel passage 7 as shown by phantom lines in FIG. 6. The sixth segment 7(f) may also communicate with fuel from the first segment 7(a) as can be appreciated in FIG. 4. In operation, the segment 7(f) can convey fuel to the pressure chamber 16. If the force on the diaphragm 15(c) provided by fuel pressure communicated to the pressure chamber 16 is less than the force provided by the spring 15(d) and the resistance of the diaphragm to flexing, the control valve 15 remains open and fuel can flow through the second fuel path 14 into the intake 11. The spring 15(d) can be chosen to provide a desired force depending on the fuels that will be used with the device 1. Depending on the pressure of the stored fuels, the spring 15(d) may be chosen to provide a force greater than the pressure exerted on the diaphragm 15(c) in the diaphragm pressure chamber 16 from the lower pressure fuel while simultaneously providing a force less than the pressure exerted on the diaphragm 15(c) by the higher-pressure fuel.

In one implementation, if fuel is supplied to the device 1 from the propane gas cylinder 3, stored at a lower pressure than the fuel in the butane gas cylinder 2, the spring 15(d) may be chosen to provide a force greater than that of the fuel supplied so that the pressure of the fuel in the diaphragm pressure chamber 16 may not displace the valve member 15(b) toward the valve seat 15(a) and stop fuel from flowing through the second fuel path 14 to the intake 11. Alternatively, if the device 1 is supplied with fuel from the butane gas cylinder 3, stored at a pressure higher than the fuel stored in the propane gas cylinder 2, the pressure of the fuel supplied to the diaphragm pressure chamber 16 may be greater than the force of the spring 15(d) and sufficient to displace the valve member 15(b), moving the member 15(b) into contact with the valve seat 15(a) closing the control valve 15 and stopping the flow of fuel through the second fuel path 14.

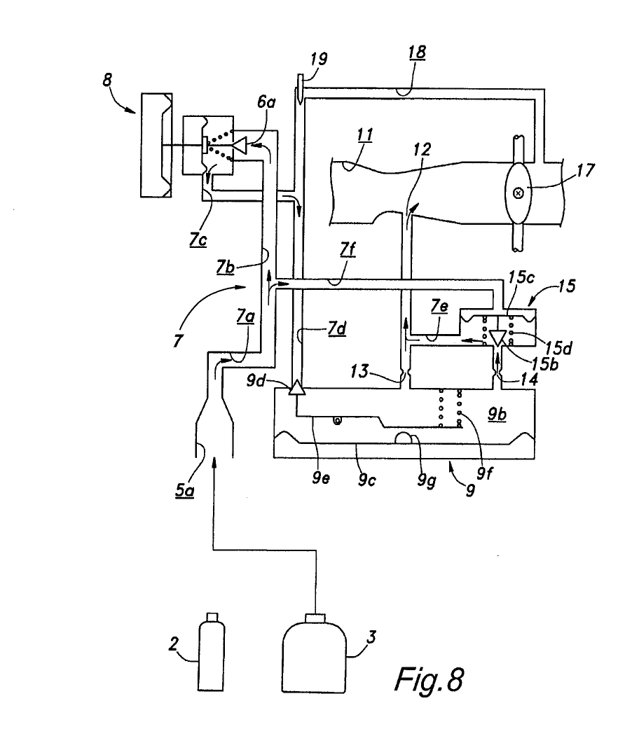

FIG. 8 illustrates another exemplary embodiment of a mixing device 1 supplied with fuel from a propane gas cylinder 3 connected to the gas fuel inlet 5(a) and operated to supply an engine with fuel. The propane fuel may pass through the first section 7(a) and reach the second section 7(b). When the engine is started, the negative pressure generated at the intake may open the valve member 6(a) thereby opening the shut-off valve 8 to permit the propane fuel in the second section 7(b) to be admitted to the third section 7(c) and fourth section 7(d). Fuel to support, for example, starting and initial operation of the engine is provided through the bypass passage 18 and jet 19. Air flow in the intake bore 11 caused by the starting of the engine creates a drop in pressure in the pressure regulating chamber 9(b) through the first fuel path 13 and/or the second fuel path 14 into the fuel ejection nozzle 12.

As the pressure in chamber 9(b) decreases, the diaphragm 9(c) moves toward the fuel pressure control lever 9(e) and the pressure member 9(g) integral with the diaphragm 9(c) engages the fuel pressure control lever 9(e), pivots the lever 9(e), and opens the valve member 9(d). As a result, the propane fuel in the fourth section 7(d) may flow into the pressure regulating chamber 9(b) and raise the fuel pressure in the pressure regulating chamber 9(b). When the fuel pressure increases to a point where the diaphragm 9(c) and pressure member 9(g) may move away from the fuel pressure control lever 9(e) and restore the lever 9(e) to the original position provided by the spring force of the spring 9(f), the valve member 9(d) may close. In this manner, the fuel pressure in the pressure regulating chamber 9(b) may be maintained within a substantially constant range.

The propane fuel is communicated to the sixth section 7(f) that may branch off from the second section 7(b). The diaphragm 15(c) of the control valve 15 may then be subjected to the pressure of the propane fuel. The force of the spring 15(d) may act upon the diaphragm 15(c) in the direction to open the valve member 15(b). The spring 15(c) may provide a force on the diaphragm 15(c) that is greater than the force of the propane fuel acting on the diaphragm 15(c) so that the valve member 15(b) remains open.

Accordingly, the propane fuel in the pressure regulating chamber 9(b) may flow through both the first fuel path 13 and second fuel path 14, and into to the intake bore 11 from the fuel ejection nozzle 12. In one implementation, the fuel paths 13 and 14 may be configured such that fuel entering both paths 13 and 14 may flow at an appropriate rate when the fuel pressure supplied from the propane gas cylinder is about 2.7 kPa.

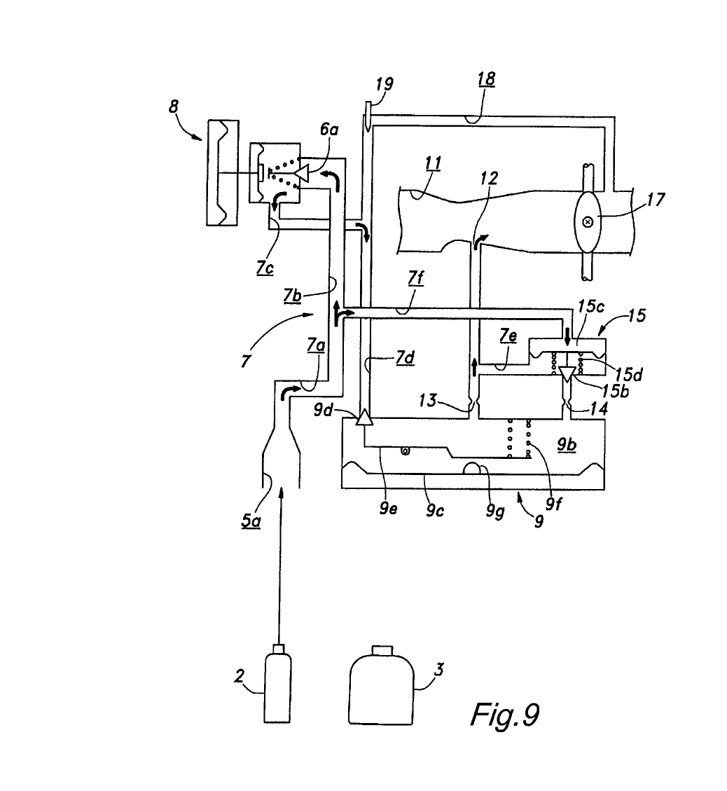

FIG. 9 illustrates an exemplary embodiment of a mixing device 1 supplied with fuel from a butane gas cylinder 2 connected to the gas fuel inlet 5(a) and operated to supply an engine with fuel. Butane fuel may be introduced into the first section 7(a) and second section 7(b), whereupon it acts on and opens the shut-off valve 8 and flows and flow into the fourth section 7(d). The fuel flows through the bypass jet 19 or bleed passage restriction and bypass passage 18 or bleed passage to support, for example, engine starting and initial engine operation. Butane fuel may also flow from the first section 7(a) to the sixth section 7(f) and apply pressure to the diaphragm 15(c) of the control valve 15 in a similar way that the propane fuel did. However, the butane fuel used here may have a pressure of about 5.9 kPa, which in the implementation shown, is sufficient to close the control valve 15. Accordingly, the valve member 15(b) may remain closed when butane fuel is used to restrict or prevent fuel flow through the second fuel path 14, as illustrated in FIG. 9. In this case, the butane fuel in the pressure regulating chamber 9(b) may flow only through the first fuel path 13. The first fuel path 13 may be configured to flow a sufficient amount of fuel for engine operation when butane fuel is used.

Accordingly, when sizing the two fuel paths 13 and 14, the first fuel path 13 may be adapted for use with a first fuel, such as butane fuel, while the second fuel path 14 may be adapted for use with a second fuel, such as propane fuel when used in conjunction with the first fuel path 13. As discussed above, the fuel paths to be used with a given fuel can be automatically selected based on a difference in pressure of the fuels that may be used. In this way, an end user does not have to manually control a valve to switch between fuels.

It should be recognized that the embodiments of the mixture device assembly discussed above are intended to be illustrative of some presently preferred embodiments of the invention, and not limiting. Various modifications within the spirit and scope of the invention will be readily apparent to those skilled in the art. The invention is defined by the claims that follow.

1. A fuel mixing device adapted to provide fuel to an engine, comprising:
a fuel passage adapted to communicate fuel from at least one of a first fuel source or a second fuel source provided at a higher pressure than the first fuel with at least one of a first fuel path or a second fuel path; and
a control valve communicated with the fuel passage and adapted to selectively prevent fuel from being delivered out of the device from the second fuel path based on the pressure of fuel within the fuel passage, wherein the valve permits fuel flow through the second fuel path and out of the device when the first fuel is provided in the fuel passage so that the first fuel flows out of the device through both the first and second fuel paths, and the valve prevents fuel flow through the second fuel path and out of the device when the second fuel is provided in the fuel passage so that the second fuel flows out of the device only through the first fuel path.

2. The fuel mixing device of claim 1, wherein the first fuel path includes a restriction sized to flow fuel for operating an engine using fuel only from the second fuel source.

3. The fuel mixing device of claim 2, wherein the second fuel path includes a restriction sized to flow fuel for operating the engine using both the first fuel path and the second fuel path each flowing fuel from a first fuel source to the engine.

4. The fuel mixing device of claim 1, further comprising a pressure regulator having an atmospheric chamber and a pressure regulating chamber separated by a diaphragm.

5. The fuel mixing device of claim 4, wherein the pressure regulator further comprises a valve member actuated by the diaphragm that opens and closes a communication port between the pressure regulating chamber and the first and second fuel paths.

6. The fuel mixing device of claim 4, further comprising a shut-off valve communicated with the fuel passage and adapted to selectively permit fuel flow in the fuel passage downstream of the shut-off valve when the engine is operating.

7. The fuel mixing device of claim 6, further comprising a main body having a first surface and a second surface substantially perpendicular to each other, wherein the first surface carries the shut-off valve and the second surface carries the pressure regulator.

8. The fuel mixing device of claim 6, wherein the shut-off valve further comprises a diaphragm and a valve member selectively driven by the diaphragm.

9. The fuel mixing device of claim 1 wherein the fuel passage includes a bleed passage through which fuel is provided to the engine independently of the first fuel path and the second fuel path.

10. The fuel mixing device of claim 1, wherein the valve includes a diaphragm and a valve member selectively driven by the diaphragm.

11. A fuel mixing device to control the flow to an engine of at least one of a first fuel or a second fuel provided at a higher pressure than the first fuel, comprising:
a fuel passage through which fuel flows and capable of receiving the first fuel or the second fuel;
a shut-off valve communicated with the fuel passage and adapted to selectively permit fuel flow in the fuel passage downstream of the shut-off valve when the engine is operating;
a pressure regulator disposed downstream of the shut-off valve and adapted to receive fuel from at least a portion of the fuel passage;
a first fuel path disposed downstream of the pressure regulator;
a second fuel path disposed downstream of the pressure regulator; and
a control valve communicated with fuel in the fuel passage that, when closed, prevents fuel flow from the second fuel path to the engine, wherein the control valve is responsive to the pressure of fuel acting on the valve to permit fuel flow through the second fuel path and out of the device when the first fuel is provided in the fuel passage so that the first fuel flows out of the device through both the first and second fuel paths, and the control valve prevents fuel flow through the second fuel path and out of the device when the second fuel is provided in the fuel passage so that the second fuel flows out of the device only through the first fuel path.

12. The fuel mixing device of claim 11, wherein the first fuel path includes a restriction sized to flow fuel for operating the engine using only the second fuel.

13. The fuel mixing device of claim 11, wherein the second fuel path includes a restriction sized to flow the first fuel to the engine using both the first fuel path and the second fuel path.

14. The fuel mixing device of claim 11, wherein the pressure regulator uses an atmospheric chamber and a pressure regulating chamber separated by a diaphragm.

15. The fuel mixing device of claim 14, wherein the pressure regulator further comprises a valve member actuated by the diaphragm that opens and closes a communication port between the pressure regulating chamber and the first and second fuel paths.

16. The fuel mixing device of claim 11, further comprising a main body having a first surface and a second surface substantially perpendicular to each other, wherein the first surface carries the shut-off valve and the second surface carries the pressure regulator.

17. The fuel mixing device of claim 11, wherein the shut-off valve further comprises a diaphragm and a valve member selectively driven by the diaphragm.

18. The fuel mixing device of claim 11, wherein the control valve includes a diaphragm and a valve member selectively driven by the diaphragm.

19. The fuel mixing device of claim 11 wherein the fuel passage includes a bleed passage through which fuel is provided to the engine independently of the first fuel path and the second fuel path.

20. A fuel mixing device to control the flow to an engine of at least one of a first fuel or a second fuel provided at a higher pressure than the first fuel, comprising:
a body including an intake bore through which air flows and a fuel passage through which fuel flows and which is capable of receiving the first fuel or the second fuel and routing fuel toward the intake bore;
a shut-off valve communicated with the fuel passage and adapted to selectively permit fuel flow in the fuel passage downstream of the shut-off valve when the engine is operating;
a pressure regulator disposed downstream of the shut-off valve and adapted to receive fuel from at least a portion of the fuel passage;
a first fuel path disposed in the flow of fuel downstream of the pressure regulator and upstream of the intake bore;
a second fuel path disposed in the flow of fuel downstream of the pressure regulator and upstream of the intake bore; and
a control valve communicated with fuel in the fuel passage and, when closed, the control valve prevents fuel flow from the second fuel path to the engine, wherein the control valve is responsive to the pressure of fuel acting on the control valve to permit fuel flow to the intake bore through the second fuel path when the first fuel is provided in the fuel passage so that the first fuel flows out of the device through both the first and second fuel paths, and the control valve prevents fuel flow to the intake bore through the second fuel path when the second fuel is provided in the fuel passage so that the second fuel flows out of the device only through the first fuel path.

21. The mixing device of claim 20 wherein the fuel passage includes a bleed passage downstream of the shut-off valve and through which fuel is provided to the intake bore independently of the pressure regulator or the first fuel path or the second fuel path.

22. The mixing device of claim 20 which also includes a restriction in the bleed passage to control the flow rate of fuel delivered to the intake bore through the bleed passage.
